(19) United States
(12) Patent Application Publication
(10) Pub. No.: US 2012/0224589 A1
(43) Pub. Date: Sep. 6, 2012

(54) RELAY STATION AND RELAY METHOD

(75) Inventor: Junichi SAWADA, Kawasaki (JP)

(73) Assignee: FUJITSU LIMITED, Kawasaki-shi (JP)

(21) Appl. No.: 13/336,761

(22) Filed: Dec. 23, 2011

(30) Foreign Application Priority Data
Mar. 3, 2011 (JP) 2011-047000

(51) Int. Cl. H04L 12/42

(52) U.S. Cl. 370/405

(57) ABSTRACT

A relay station for relaying data between first and second ring networks, each of the first and the second ring networks including a plurality of stations includes a first transmission and receiving circuit transmitting and receiving data to and from the first ring network; a second transmission and receiving circuit transmitting and receiving the data to and from the second ring network; and a switch that, when a destination of the data received by the first transmission and receiving circuit is one of the stations included in the second ring network, inputs the data to the second transmission and receiving circuit, and, when a destination of the data received by the second transmission and receiving circuit is another of the stations included in the first ring network, inputs the data to the first transmission and receiving circuit.

### CROSS-REFERENCE TO RELATED APPLICATIONS

This application is based upon and claims the benefit of priority of Japanese Patent Application No. 2011-047000, filed Mar. 3, 2011. The entire contents of which are incorporated herein by reference.

### FIELD

The embodiment discussed herein is related to a relay station in a communication system.

### BACKGROUND

IEEE 802.17 standard describes a ring network including RPR (Resilient Packet Ring). The RPR refers to an optical network technique to be used in a LAN (Local Area Network) including a WAN (Wide Area Network). The RPR has a duplex ring type network structure and a layer 2 (data link layer) protocol of OSI (Open System Interconnection) reference model.

As the network topology where stations are connected, the IEEE 802.17 standard describes a ring topology and a cascade topology.

Japanese Laid-open Patent Publication No. 2006-262169 discloses a technique to attain both high-speed failure switching between a plurality of interconnected rings and the minimization of a failure range in an inter-ring connection method and device for interconnecting a plurality of RPR (resilient packet ring) rings. To that end, an interconnection (interconnection station) S5 determines whether an RPR frame received from one ring #1 is a broadcast frame and resets ttl (time-to-live) of the frame so that prescribed points between identical inter-ring connection devices S4 facing in a relay destination ring #2 are cleave points CP0 and CP1 when relaying the RPR frame determined to be the broadcast frame to the other ring #2. In addition, topology information of one ring is transmitted to the other ring, the topology information of each ring is stored in a topology database, and the RPR frame is relayed (unicast) between the rings by referring to the topology database on the basis of the destination address of the RPR frame.

As describe above, Japanese Laid-open Patent Publication No. 2006-262169 discloses a technique mutually connecting plural RPRs.

### SUMMARY

According to an aspect, a relay station for relaying data between first and second ring networks, each of the first and the second ring networks including a plurality of stations includes a first transmission and receiving circuit transmitting and receiving data to and from the first ring network; a second transmission and receiving circuit transmitting and receiving the data to and from the second ring network; and a switch that, when a destination of the data received by the first transmission and receiving circuit is one of the stations included in the second ring network, inputs the data to the second transmission and receiving circuit, and, when a destination of the data received by the second transmission and receiving circuit is another of the stations included in the first ring network, inputs the data to the first transmission and receiving circuit.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates an example of a ring topology;

FIG. 2 illustrates another example of the ring topology;

FIG. 3 illustrates an example where failures occur in a single ring network;

FIG. 4 illustrates an example where two ring networks are connected;

FIG. 5 illustrates an example of a communication system;

FIG. 6 illustrates another example of the communication system;

FIG. 7 illustrates another example of the communication system where a failure occurs in a transmission path;

FIG. 8 is an example block diagram of a relay station;

FIG. 9 is an example block diagram of a station;

FIG. 10 illustrates another example of the communication system;

FIG. 11 illustrates an example of route information in the station;

FIG. 12 illustrates an example of route information in the relay station;

FIG. 13 is an example flowchart of an operation of the station;

FIG. 14 is an example flowchart of an operation of the relay station;

FIG. 15 illustrates an example operation of the communication system;

FIG. 16 illustrates an example of the route information and load information in the station;

FIG. 17 illustrates an example of the route information and the load information in the relay station;

FIG. 18 is another example flowchart of an operation of the station;

FIG. 19 is another example flowchart of an operation of the relay station;

FIG. 20 illustrates a modified example operation of the communication system;

FIG. 21 illustrates another example of the route information in the station; and

FIG. 22 illustrates another example of the route information in the relay station.

### DESCRIPTION OF EMBODIMENT

First, a case will be described where a network is formed in a wide area using the ring topology.

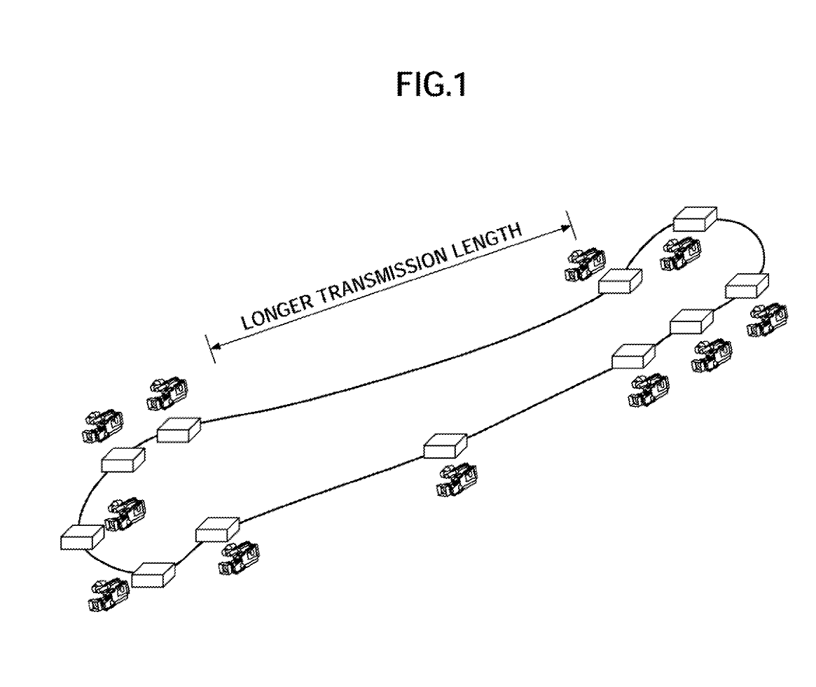

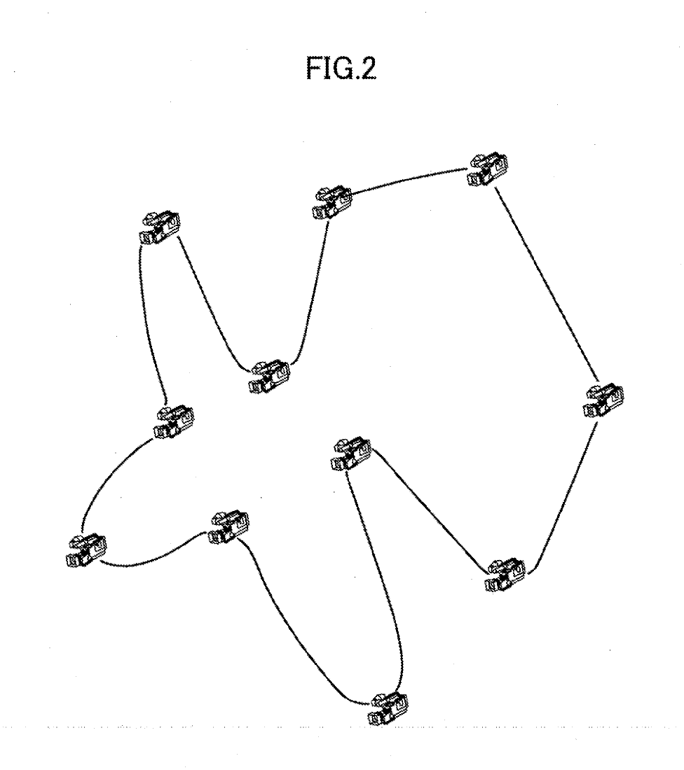

FIGS. 1 and 2 illustrate examples of the ring topology of a wide area monitoring network for monitoring a water way (river) or roads.

In the examples illustrated in FIGS. 1 and 2, each station has a camera. When the wide area monitoring network using the ring topology is formed, as illustrated in FIG. 1, a distance between the stations may be increased. As a result, transmission efficiency may be reduced, and the transmission may become degraded. Further, as illustrated in FIG. 2, the order of connecting the stations may become complicated. As a result, the efficiency of the route by using optical fibers between the stations may be reduced.

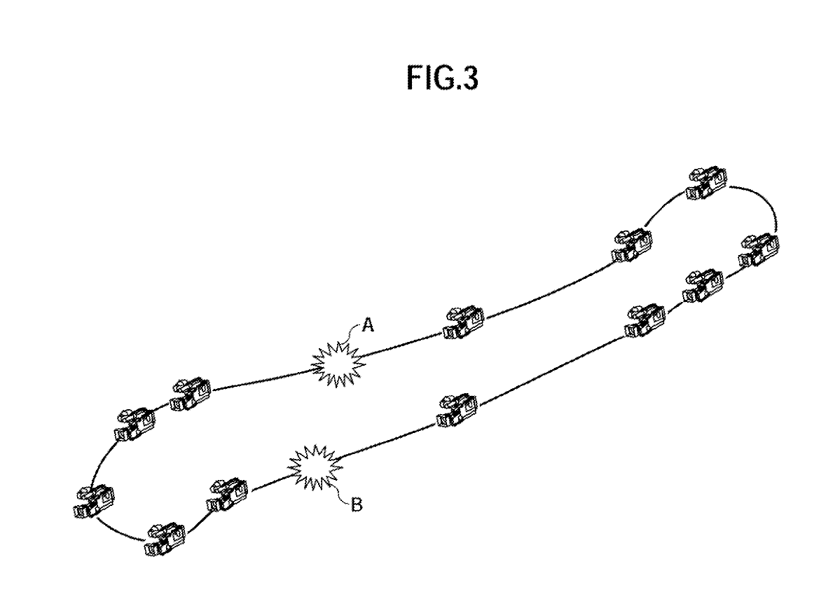

FIG. 3 illustrates an example of a network including a single ring. In the example of FIG. 3, the ring network including stations is formed, and cameras are connected to all the stations. In the example of FIG. 3, when a failure occurs at two points (A, B) on the route of the network made of a single ring, the network may be separated and some stations may be isolated.

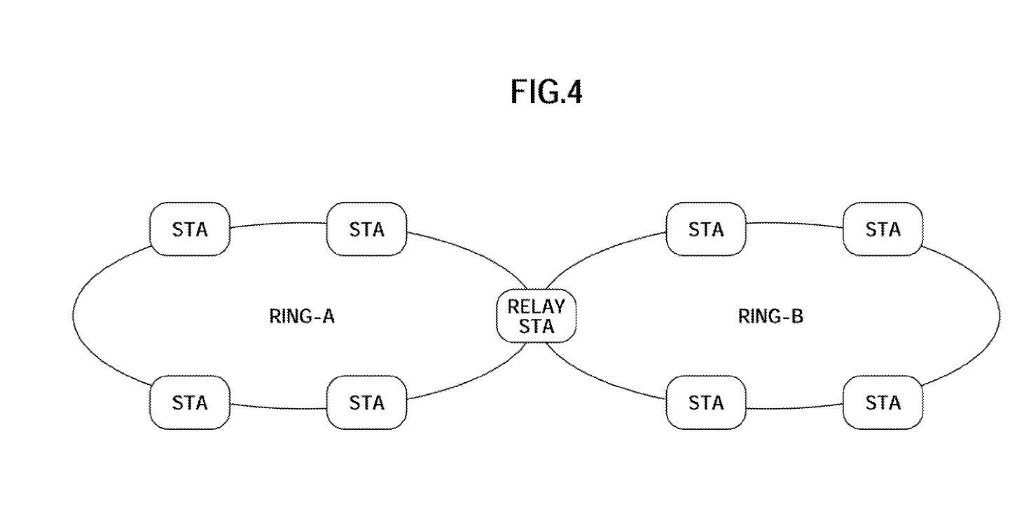

Next, a case is described where a network is formed in a wide area based on two ring networks. FIG. 4 illustrates an example where a network is formed in a wide area using two ring networks. When two ring networks (Ring-A, Ring-B) are mutually connected via a relay station (relay ST), it may be preferable for the relay station to convert RPR format data (hereinafter “RPR data”) from a station (STA) included in one ring network (Ring-A) into LAN format data (hereinafter “LAN data”) for the Ethernet (registered trademark) or the like, and further convert the LAN data into the RPR data to transmit the RPR data to a station (STA) included in the other ring network (Ring-B). This is because the relay station cannot directly transmit the RPR data between ring networks without converting the RPR data into the LAN data.

Namely, when data are transmitted between two ring networks, the relay station may convert between the RPR data and the LAN data. Therefore, it may take more time due to the conversions, and as a result, the time delay may be increased. Further, though the bandwidth control in the RPR may be known as an advantageous feature of the RPR, the bandwidth control in the RPR may not be used on an end-to-end basis. This may be because of the conversions between the RPR data and the LAN data.

In the following, an embodiment are described with reference to the accompanying drawings. Throughout the figures, the same referential numerals are repeatedly used to describe the same elements, and repeated descriptions thereof may be omitted.

### System

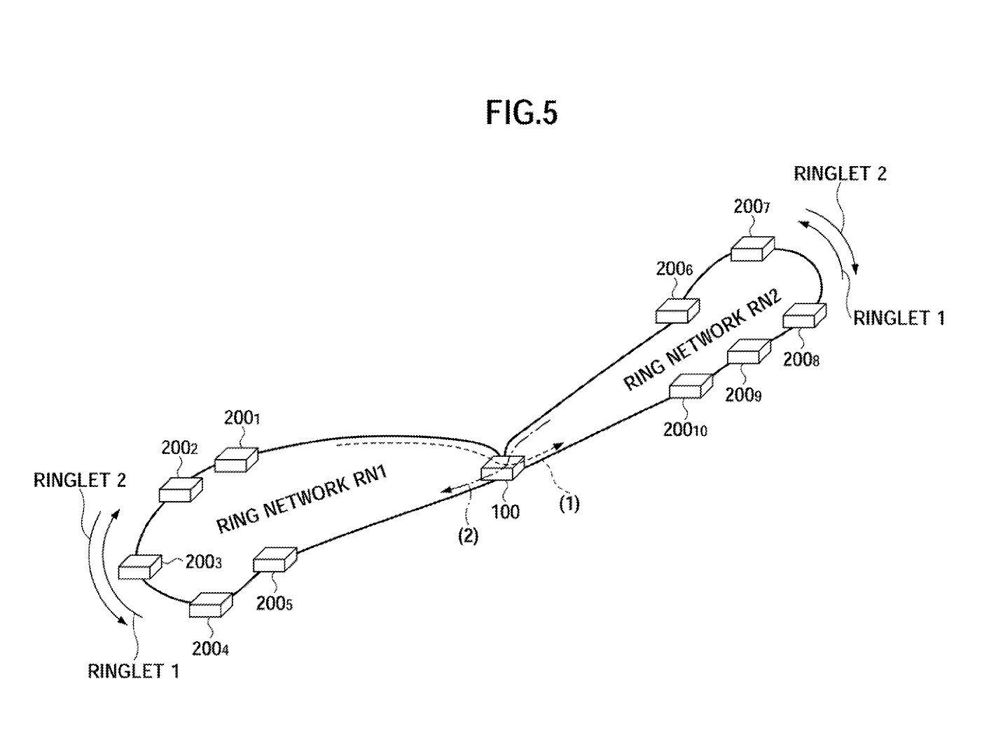

FIG. 5 illustrates an embodiment of a communication system.

The communication system may be a system based on the RPR (Resilient Packet Ring).

As illustrated in FIG. 5, the communication system includes plural stations 200ₙ (n: integers greater than zero). The stations 200ₙ may be terminal devices or ADM (Add-Drop Multiplexer) devices. Further, the communication system includes a relay station 100. FIG. 5 illustrates a case where the number of the stations 200ₙ is ten.

The plural stations 200ₙ may be connected through communication cables such as optical fibers and metal cables. Further, the plural stations 200ₙ are divided into plural groups. The stations in each of the groups constitute a ring network. FIG. 5 illustrates an example where plural stations 200₁ through 200₁₀ are divided into two groups. Specifically, the stations 200₁ through 200₅ constitute a ring-network RN1, and the stations 200₆ through 200₁₀ constitutes a ring-network RN2. However, the stations 200₁ through 200₁₀ may be divided into three or more groups.

The layout of the stations of FIG. 5 is substantially the same as that of the stations of FIG. 1. However, in FIG. 5, the relay station 100 is additionally disposed between the stations 200₁ and 200₆. Therefore, the distance between the stations may be reduced.

In the ring network RN1, the stations 200₁ through 200₅ are connected using cables in dual ring which includes two one-way rings having the directions opposite to each other. Similarly, in ring network RN2, the stations 200₆ through 200₁₀ are connected using cables in dual ring including two one-way rings having the directions opposite to each other.

The relay station 100 includes an interface including (in communication with) plural ring networks. By using the interface, the relay station 100 connects the ring networks RN1 and RN2. For example, when a station in one ring network transmits the RPR data addressed to a station in the other ring network, the relay station 100 connects the ring networks RN1 and RN2 in a manner such that the RPR data can be received by the station in the other ring network without passing along the same route again.

Namely, the relay station 100 connects the ring networks RN1 and RN2 as if the ring networks RN1 and RN2 were a single ring network. In other words, the relay station 100 connects the stations in the ring networks RN1 and RN2 in a unicursal form (in a one-stroke drawing form).

The ring network RN1 includes one ring in which data can be transmitted in a ringlet 1 direction (i.e., in the clockwise direction) in FIG. 5 and the other ring in which data can be transmitted in a ringlet 2 direction (i.e., in the counterclockwise direction) in FIG. 5.

When the ring network RN1 is connected with the ring network RN2 through the relay station 100, in the ring network 2, the ringlet 1 direction corresponds to the counterclockwise direction and the ringlet 2 direction corresponds to the clockwise direction as illustrated in FIG. 5.

The relay station 100 transmits packet data from the station 200₁ to the station 200₁₀ (see dotted arrow (1) in FIG. 5). Further, the relay station 100 may transmit packet data from the station 200₁₀ to the station 200₁. Further, the relay station 100 transmits packet data from the station 200₆ to the station 200₅ (see dashed-dotted arrow (2) in FIG. 5).

Further, the relay station 100 may transmit packet data from the station 200₅ to the station 200₆. In those cases, however, no conversions between the RPR data and the LAN data are performed. Namely, the relay station 100 directly transfers the packet data from the station to the other station while maintaining the RPR data (without conversion). As a result, the packet data is transmitted in the order of station 200₁, station 200₁₀, station 200₉, station 200₈, station 200₇, station 200₆, relay station 100, station 200₅, station 200₄, station 200₃, station 200₂, and station 200₁.

Further, the relay station 100 may transfer the packet data from the station 200₁ to the station 200₆, and transfer the packet data from the station 200₆ to the station 200₁. In those cases as well, no conversion between the RPR data and the LAN data are performed. Namely, the relay station directly transfers the RPR data from a station in one ring network to a station in the other ring network while maintaining the RPR data (without any conversion from the RPR data).

By using the relay station in this embodiment, the configuration of the network may be simplified. Further, the transmissions between different ring networks may be performed without performing the conversions between the RPR data and the LAN data.

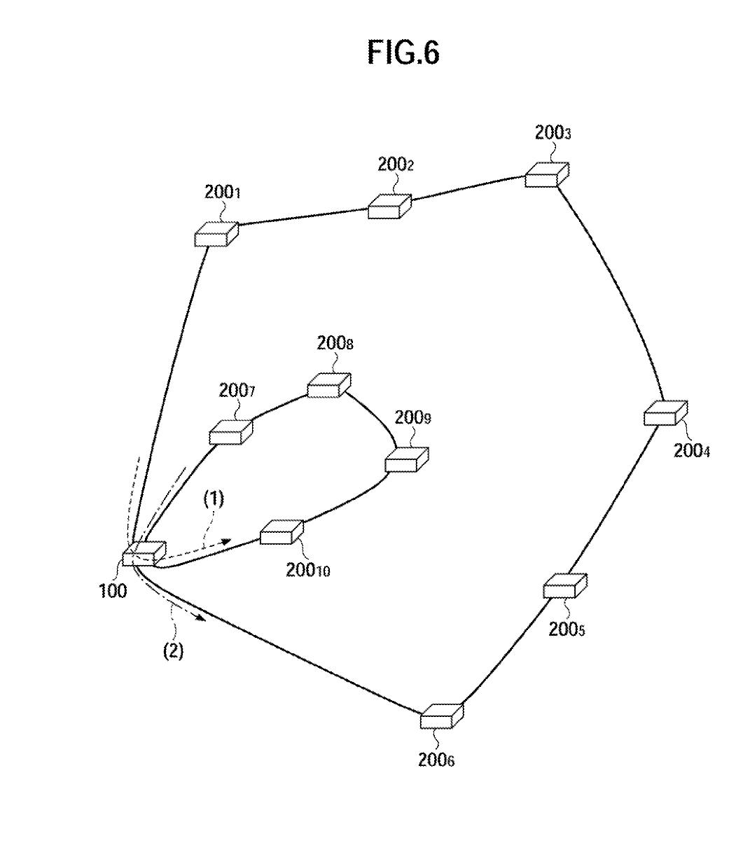

FIG. 6 illustrates an example where the configuration of the network is simplified. More specifically, in the example of FIG. 6, the configuration of the network described with reference to FIG. 2 is simplified by using the relay station 100. Namely, the layout of the stations in FIG. 6 is the same as the layout of the stations in FIG. 2.

In FIG. 6, the relay station 100 transfers the packet data from the station 200₁ to the station 200₁₀ (dotted line (1) in FIG. 6). Further, the relay station 100 may transfer the packet data from the station 200₁₀ to the station 200₁. Further, the relay station 100 transfers the packet data from the station 200₇ to the station 200₆ (dashed-dotted line (2) in FIG. 6).

Further, the relay station 100 may transfer the packet data from the station 200₆ to the station 200₇. In those cases, no conversions between the RPR data and the LAN data are performed. Namely, the relay station 100 directly transfers the packet data from the station to the other station while maintaining the RPR data (without conversion). As a result, the packet data is transmitted in the order of station 200₁, station 200₁₀, station 200₉, station 200₈, station 200₇, station 200₆, station 200₅, station 200₄, station 200₃, station 200₂, and station 200₁.

Further, the relay station 100 may transfer the packet data from the station 200₁ to the station 200₇, and transfer the packet data from the station 200₆ to the station 200₁₀. In those cases as well, no conversion between the RPR data and the LAN data are performed. Namely, the relay station directly transfers the RPR data from a station in one ring network to a station in the other ring network while maintaining the RPR data (without any conversion from the RPR data).

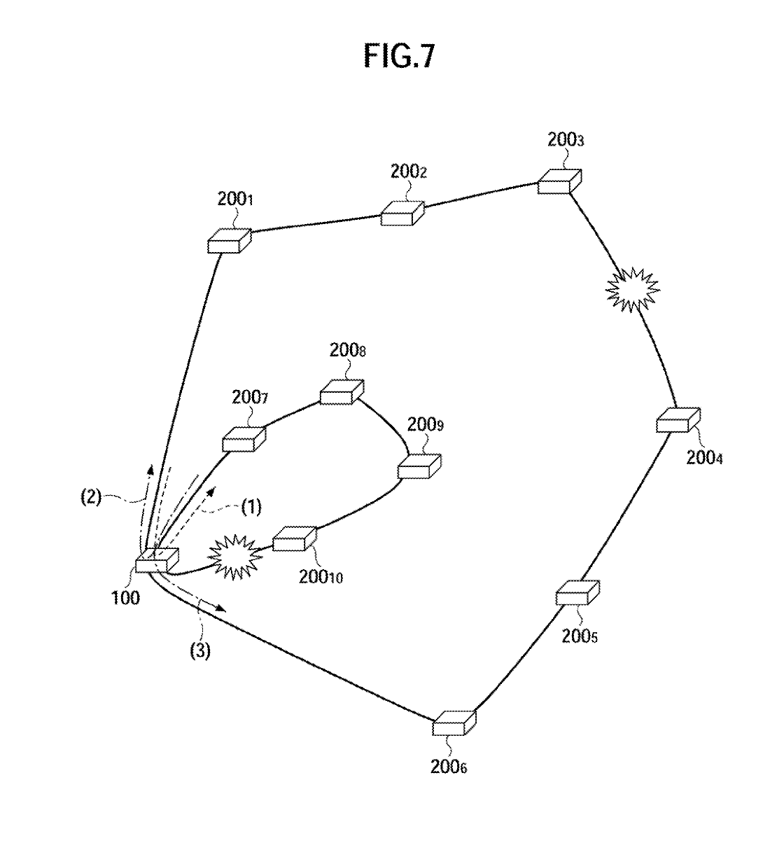

FIG. 7 illustrates a case where a failure occurs in the network of FIG. 6. In the example of FIG. 7, a failure occurs between the relay station 100 and the station 200₁₀ and between the station 200₃ and the station 200₄ (hereinafter, the point where a failure occurs may be referred to as a failure point). In this case, the relay station 100 transfers the RPR data from the station 200₁ to the station 200₇ in a manner such that the RPR data does not pass through the failure point.

Further, the relay station 100 transfers the RPR data from the station 200₇ to the station 200₁ or the station 200₆ in a manner such that the RPR data does not pass through the failure point. Whether the RPR data are to be transferred to the station 200₁ or the station 200₆ is determined by the relay station 100 based on routing information across the entire ring network. As illustrated in FIG. 1, when the number of the failure points is one or zero in each of the ring networks, the communications (data transmissions) may be performed normally.

### Relay Station

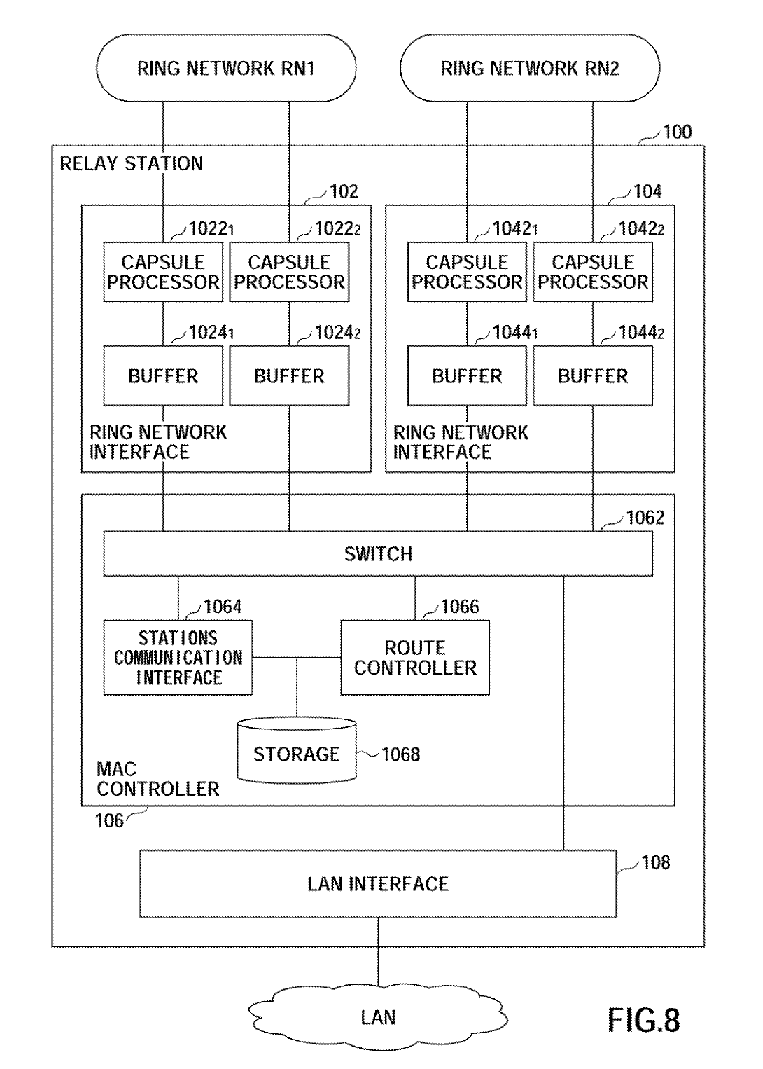

FIG. 8 is an example block diagram of the relay station 100.

As illustrated in FIG. 8, the relay station 100 includes a ring network interface 102 serving as an interface between the relay station 100 and the ring network RN1.

The ring network interface 102 includes a capsule processor 1022₁. The capsule processor 1022₁ is connected with the ring network RN1. The capsule processor 1022₁ inputs (receives) a LAN frame or an RPR frame. Upon receipt of the LAN frame, the capsule processor 1022₁ encapsulates the LAN frame into the RPR frame.

The capsule processor 1022₁ outputs (transmits) the RPR frame to the ring network RN1. For example, the capsule processor 1022₁ transmits the RPR frame in the ringlet 1 direction of the ring network RN1. Further, the capsule processor 1022₁ receives the RPR frame from the ring network RN1, and stores the received RPR frame in a buffer 1024₁. Further, the capsule processor 1022₁ decapsulates the RPR frame from the ring network RN1, and stores the decapsulated RPR frame in the buffer 1024₁. The decapsulated RPR frame is output from the relay station 100.

The ring network interface 102 includes a capsule processor 1022₂. The capsule processor 1022₂ is connected with the ring network RN1. The capsule processor 1022₂ inputs (receives) the LAN frame or the RPR frame. Upon receipt of the LAN frame, the capsule processor 1022₂ encapsulates the LAN frame into the RPR frame.

The capsule processor 1022₂ outputs (transmits) the RPR frame to the ring network RN1. For example, the capsule processor 1022₂ transmits the RPR frame in the ringlet 2 direction of the ring network RN1. Further, the capsule processor 1022₂ receives the RPR frame from the ring network RN1, and stores the received RPR frame in a buffer 1024₂. Further, the capsule processor 1022₂ decapsulates the RPR frame from the ring network RN1, and stores the decapsulated RPR frame in the buffer 1024₂. The decapsulated RPR frame is output from the relay station 100.

The ring network interface 102 includes the buffer 1024₁. The buffer 1024₁ is connected to the capsule processor 1022₁. The buffer 1024₁ stores the LAN frame or the RPR frame.

The ring network interface 102 includes the buffer 1024₂. The buffer 1024₂ is connected to the capsule processor 1022₂. The buffer 1024₂ stores the LAN frame or the RPR frame.

The relay station 100 includes a ring network interface 104 serving as an interface between the relay station 100 and the ring network RN2.

The ring network interface 104 includes a capsule processor 1042₁. The capsule processor 1042₁ is connected with the ring network RN2. The capsule processor 1042₁ inputs (receives) the LAN frame or the RPR frame. Upon receipt of the LAN frame, the capsule processor 1042₁ encapsulates the LAN frame into the RPR frame.

The capsule processor 1042₁ outputs (transmits) the RPR frame to the ring network RN2. For example, the capsule processor 1042₁ transmits the RPR frame in the ringlet 1 direction of the ring network RN2. Further, the capsule processor 1042₁ receives the RPR frame from the ring network RN2, and stores the received RPR frame in a buffer 1044₁. Further, the capsule processor 1022₁ decapsulates the RPR frame from the ring network RN2, stores the decapsulated RPR frame in the buffer 1044₁. The decapsulated RPR frame is output from the relay station 100.

The ring network interface 104 includes a capsule processor 1042₂. The capsule processor 1042₂ is connected with the ring network RN2. The capsule processor 1042₂ inputs (receives) the LAN frame or the RPR frame. Upon receipt of the LAN frame, the capsule processor 1042₂ encapsulates the LAN frame into the RPR frame.

The capsule processor 1042₂ outputs (transmits) the RPR frame to the ring network RN2. For example, the capsule processor 1042₂ transmits the RPR frame in the ringlet 2 direction of the ring network RN2. Further, the capsule processor 1042₂ receives the RPR frame from the ring network RN2, and stores the received RPR frame in a buffer 1044₂. Further, the capsule processor 1042₂ decapsulates the RPR frame from the ring network RN2, and stores the decapsulated RPR frame in the buffer 1044₂. The decapsulated RPR frame is output from the relay station 100.

The ring network interface 104 includes the buffer 1044₁. The buffer 1044₁ is connected to the capsule processor 1042₁. The buffer 1044₁ stores the LAN frame or the RPR frame.

The ring network interface 104 includes the buffer 1044₂. The buffer 1044₂ is connected to the capsule processor 1042₂. The buffer 1044₂ stores the LAN frame or the RPR frame.

The relay station 100 includes a MAC controller 106. The MAC controller 106 is connected to the ring network interfaces 102 and 104.

The MAC controller 106 includes a switch 1062. The switch 1062 is connected to the buffers 1024₁, 1024₂, 1044₁, and 1044₂. The switch 1062 switches the transmission destination of the LAN frame to any of the buffers 1024₁, 1024₂, 1044₁, and 1044₂ so that the LAN frame is transmitted to any of the buffers 1024₁, 1024₂, 1044₁, and 1044₂. Further, the switch 1062 determines the transmission destination of the RPR frame to be input from the capsule processor via the buffer, so that the RPR frame is transmitted to the determined transmission destination.

The MAC controller 106 includes a route controller 1066. In this communication system, the route controller 1066 controls the transmission path of the packet data to be transmitted. The route controller 1066 performs routing control based on route information and load information to be stored in a storage 1068.

The MAC controller 106 includes a stations communication interface 1064. The stations communication interface 1064 is connected to the switch 1062. The stations communication interface 1064 is provided as an interface of the communications between stations.

The MAC controller 106 includes the storage 1068. The storage 1068 is connected to the stations communication interface 1064 and the route controller 1066. The storage 1068 stores the routing control and the load information.

The relay station 100 includes a LAN interface 108. The LAN interface 108 is connected to the switch 1062. The LAN interface 108 serves as an interface between the relay station 100 and the LAN. The LAN interface 108 transmits the LAN frame from the LAN to the switch 1062.

### Station

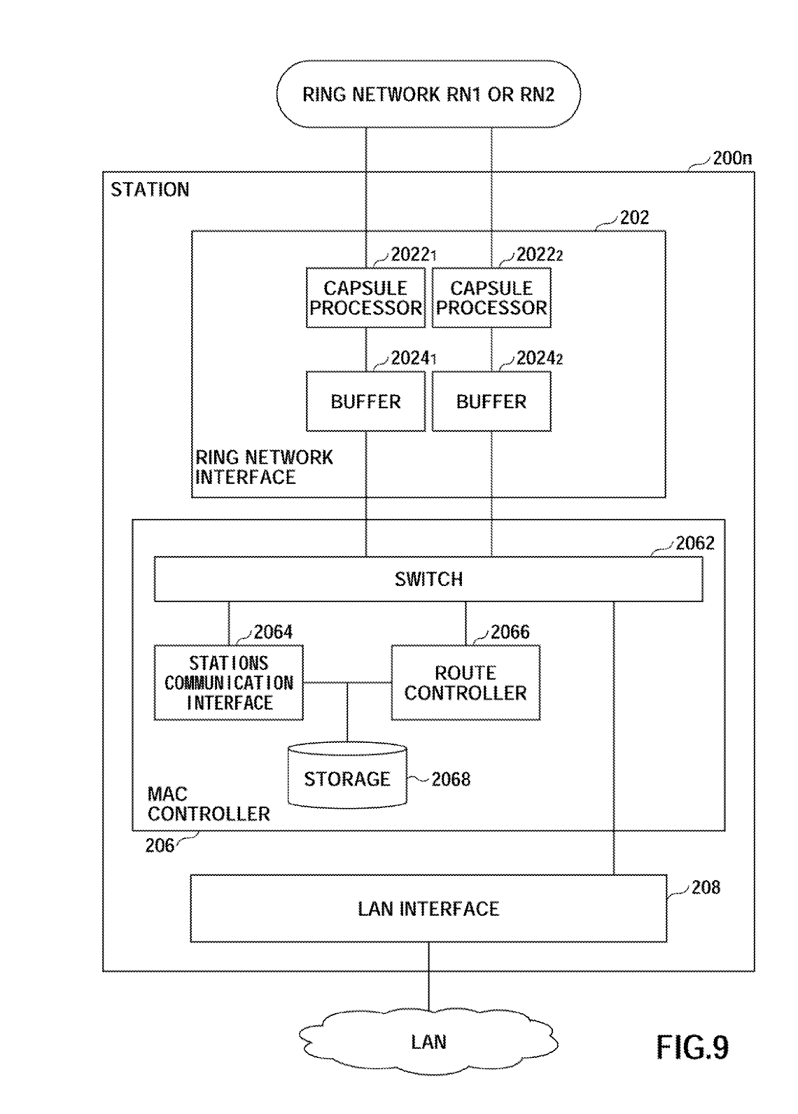

FIG. 9 is an example block diagram of the station 200ₙ.

As illustrated in FIG. 9, the station 200ₙ includes a ring network interface 202 serving as an interface between the station 200ₙ and the ring network RN1.

The ring network interface 202 includes a capsule processor 2022₁. The capsule processor 2022₁ is connected with the ring network RN1 or RN2. The capsule processor 2022₁ inputs (receives) the LAN frame or the RPR frame. Upon receipt of the LAN frame, the capsule processor 2022₁ encapsulates the LAN frame into the RPR frame.

The capsule processor 2022₁ outputs (transmits) the RPR frame to the ring network RN1 or RN2. For example, the capsule processor 2022₁ transmits the RPR frame in the ringlet 1 direction of the ring network RN1 or RN2. Further, the capsule processor 2022₁ receives the RPR frame from the ring network RN1 or RN2, and stores the received RPR frame in a buffer 2024₁. Further, the capsule processor 2022₁ decapsulates the RPR frame from the ring network RN1 or RN2, and stores the decapsulated RPR frame in the buffer 2024₁. The decapsulated RPR frame is output from the station 200ₙ.

The ring network interface 202 includes a capsule processor 2022₂. The capsule processor 2022₂ is connected with the ring network RN1 or RN2. The capsule processor 2022₂ inputs (receives) the LAN frame or the RPR frame. Upon receipt of the LAN frame, the capsule processor 2022₂ encapsulates the LAN frame into the RPR frame.

The capsule processor 2022₂ outputs (transmits) the RPR frame to the ring network RN1 or RN2. For example, the capsule processor 2022₂ transmits the RPR frame in the ringlet 2 direction of the ring network RN1 or RN2. Further, the capsule processor 2022₂ receives the RPR frame from the ring network RN1 or RN2, and stores the received RPR frame in a buffer 2024₂. Further, the capsule processor 2022₂ decapsulates the RPR frame from the ring network RN1 or RN2, and stores the decapsulated RPR frame in the buffer 2024₂. The decapsulated RPR frame is output from the station 200ₙ.

The ring network interface 202 includes the buffer 2024₁. The buffer 2024₁ is connected to the capsule processor 2022₁. The buffer 2024₁ stores the LAN frame or the RPR frame.

The ring network interface 202 includes the buffer 2024₂. The buffer 2024₂ is connected to the capsule processor 2022₂. The buffer 2024₂ stores the LAN frame or the RPR frame.

The station 200ₙ includes a MAC controller 206. The MAC controller 206 is connected to the ring network interface 202.

The MAC controller 206 includes a switch 2062. The switch 2062 is connected to the buffers 2024₁ and 2024₂. The switch 2062 switches the transmission destination of the LAN frame to any of the buffers 2024₁ and 2024₂ so that the LAN frame is transmitted to any of the buffers 2024₁ and 2024₂. Further, the switch 1062 determines the transmission destination of the RPR frame to be input from the capsule processor via the buffer, so that the RPR frame is transmitted to the determined transmission destination.

The MAC controller 206 includes a route controller 2066. In this communication system, the route controller 2066 controls the transmission path of the packet data to be transmitted. The route controller 2066 performs routing control based on route information and load information to be stored in a storage 2068.

The MAC controller 206 includes a stations communication interface 2064. The stations communication interface 2064 is connected to the switch 2062. The stations communication interface 2064 is provided as an interface of the communications between the stations.

The MAC controller 206 includes the storage 2068. The storage 2068 is connected to the stations communication interface 2064 and the route controller 2066. The storage 2068 stores the routing control and the load information.

The station 200ₙ includes a LAN interface 208. The LAN interface 208 is connected to the switch 2062. The LAN interface 208 serves as an interface between the station 200ₙ and the LAN. The LAN interface 208 transmits the LAN frame from the LAN to the switch 2062.

Example Operation of this Communication System Data Transmission Method 1

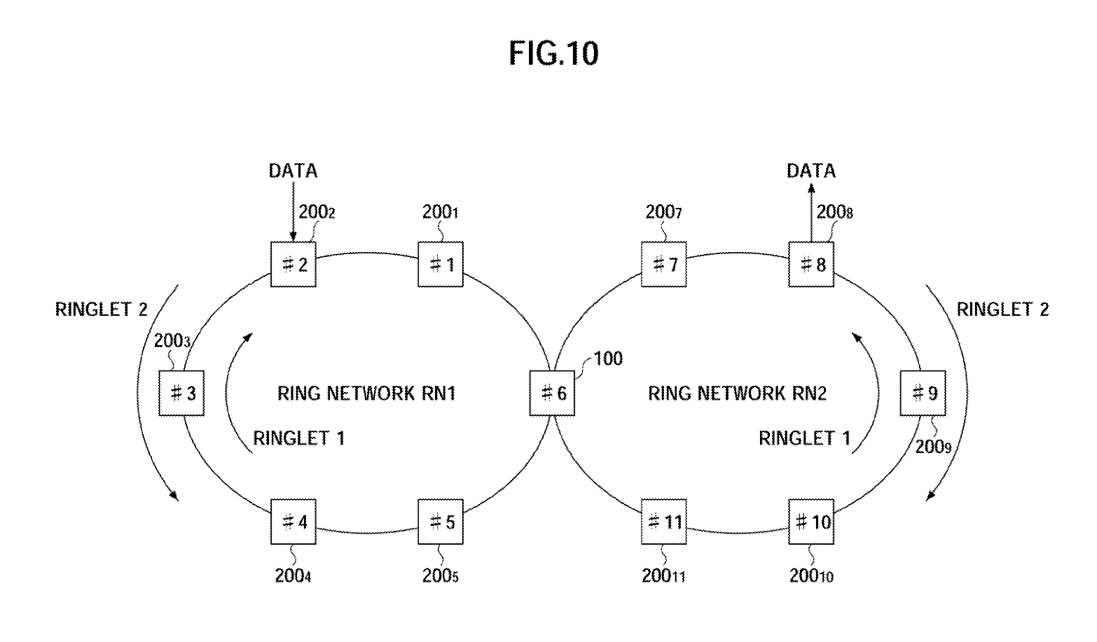

FIG. 10 illustrates an example operation 1 of a data transmission method of this communication system.

In this example, a case is described where data having been input to the station 200₂ are transmitted to the station 200₈.

In the data transmission in the communication system, it is assumed that the network information relevant to the network including the relay station 100 and the station 200ₙ is set in the relay station 100 and the station 200ₙ, respectively. Further, when the stations 200ₙ are equipped with the cameras, the information indicating the cameras may be set.

To perform the data transmission in this system, each of the stations 200ₙ broadcasts packet data to all the other stations 200ₙ in the ring network to which the stations 200ₙ belongs, the packet data being for generating the route information indicating the arranging order in the ring network. The route information may be generated in a database form. For example, the station 200ₙ may broadcast a Topology discovery and Protection Frame.

The Topology discovery and Protection Frame may be transmitted through the stations in the ring network on a unicursal route. Herein, the unicursal route includes the route (in the ringlet 1 direction) through which data are transmitted in the order of station 200₁, relay station 100, station 200₁₁, station 200₁₀, station 200₉, station 200₈, station 200₇, relay station 100, station 200₅, station 200₄, station 200₃, and station 200₂.

Further, the unicursal route further includes the route (in the ringlet 2 direction) through which data are transmitted in the order of station 200₁, station 200₂, station 200₃, station 200₄, station 200₅, relay station 100, station 200₇, station 200₈, station 200₉, station 200₁₀, station 200₁₁, and relay station 100. The process of broadcasting the Topology discovery and Protection Frame may be performed periodically or irregularly.

The relay station 100 broadcasts the identifier of the relay station 100 to all the stations 200ₙ. The process of broadcasting the identifier of the relay station 100 may be performed periodically or irregularly. The identifier of the relay station 100 may be transmitted through the stations 200ₙ along the unicursal route.

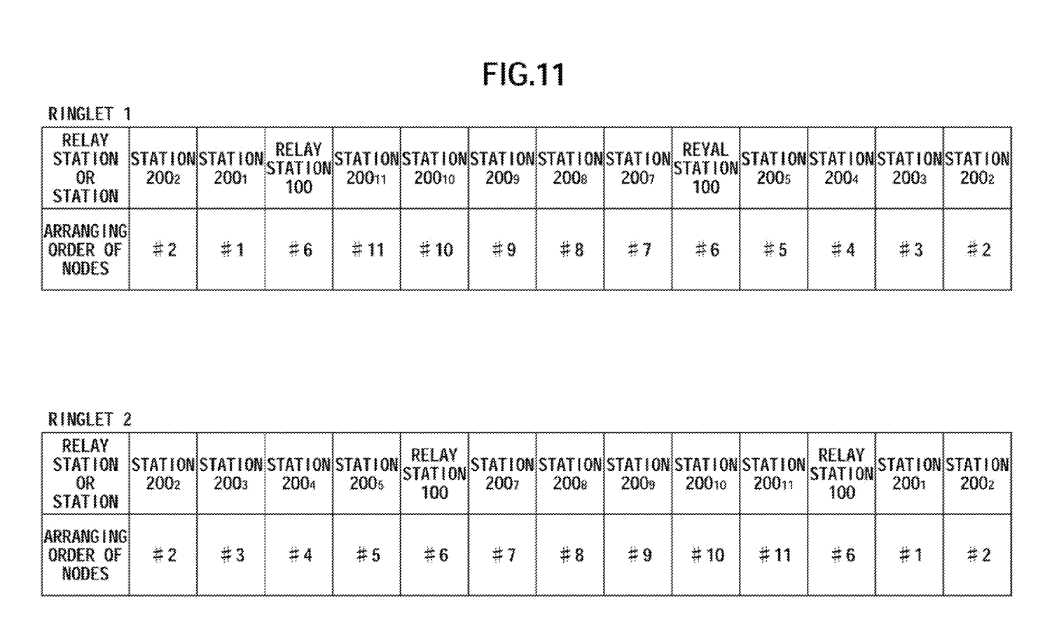

FIG. 11 illustrates example route information indicating the arranging order in the ring network and to be generated by the stations 200ₙ.

More specifically, FIG. 11 illustrates example route information to be generated by the station 200₂. In the ringlet 1 direction, the stations are arranged in the order of station 200₂ (#2), station 200₁ (#1), relay station 100 (#6), station 200₁₁ (#11), station 200₁₀ (#10), station 200₉ (#9), station 200₈ (#8), station 200₇ (#7), relay station 100 (#6), station 200₅ (#5), station 200₄ (#4), and station 200₃ (#3).

Therefore, the route information on the upper part of FIG. 11 is generated. In the ringlet 2 direction, the stations are arranged in the order of station 200₂ (#2), station 200₃ (#3), station 200₄ (#4), station 200₅ (#5), relay station 100 (#6), station 200₇ (#7), station 200₈ (#8), station 200₉ (#9), station 200₁₀ (#10), station 200₁₁ (#11), relay station 100 (#6), and station 200₁ (#1). Therefore, the route information on the lower part of FIG. 11 is generated.

When transmitting data to the station 200₈, the station 200₂ transmits data to the relay station 100. This is because the ring network RN1 to which the station 200₂ belongs differs from the ring network RN2 to which the station 200₈ belongs. When transmitting data to the relay station 100, the station 200₈ transmits the data in the ringlet 1 direction because of the shorter transmission length. In this case, as an index indicating transmission length, the number of hops (hereinafter the hop number) to the relay station 100 may be used. For example, by referring to the route information of FIG. 11, the hop number to the relay station (relay node) 100 may be obtained.

Then, the data may be transmitted in the ringlet direction having the hop number less than that in the opposite ringlet direction. In the example of FIG. 11, the hop number from the station 200₂ to the relay station 100 in the ringlet 1 direction is “2” and the hop number in the ringlet 2 direction is “4”. Therefore, the data are transmitted in the ringlet 1 direction due to lesser hop number. As a result, the data from the station 200₂ are transmitted to the relay station 100 via the station 200₁.

The relay station having received the data from the station 200₂ transmits the data to the station 200₈. When transmitting data to the station 200₈, the relay station 100 transmits the data in the ringlet 2 direction because of the shorter transmission length.

In this case, as the index indicating transmission length, the number of hops (hop number) to the station 200₈ may be used. For example, by referring to the route information generated in the relay station 100, the hop number to the station 200₈ may be obtained. Then, the data may be transmitted in the ringlet direction having the hop number less than that in the opposite ringlet direction.

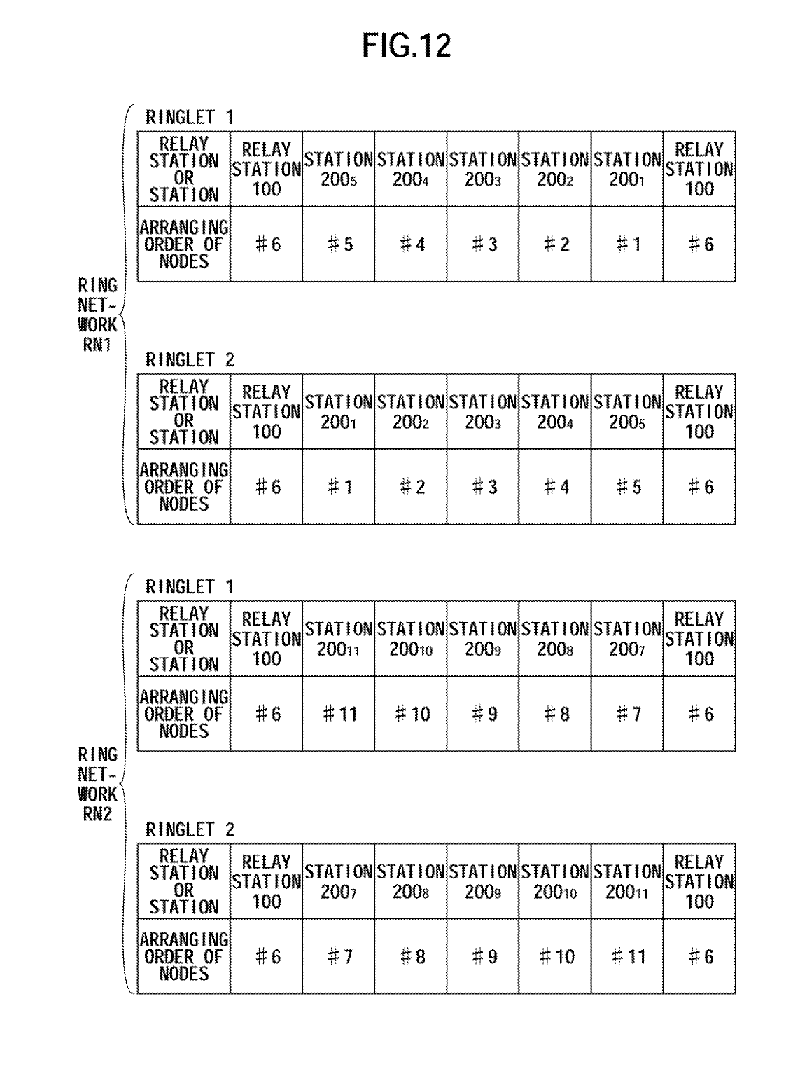

FIG. 12 illustrates example route information to be generated by the relay station 100. More specifically, the upper part of FIG. 12 illustrates the route information in the ring network RN1 and the lower part of FIG. 12 illustrates the route information in the ring network RN2.

In the example of FIG. 12, the hop number from the relay station 100 to the station 200₈ in the ringlet 1 direction is “4” and the hop number in the ringlet 2 direction is “2”. Therefore, the data is transmitted in the ringlet 2 direction due to lesser hop number. As a result, the data from the relay station 100 are transmitted to the station 200₈ via the station 200₇.

By using the data transmission method described above, it may become possible to transmit data using a route having a shorter transmission distance. Therefore, the transmission time may be reduced. In the example of FIG. 10, data can be transmitted from the station 200₂ the station 200₈ in four hops.

### Operational Flow of Station 200ₙ

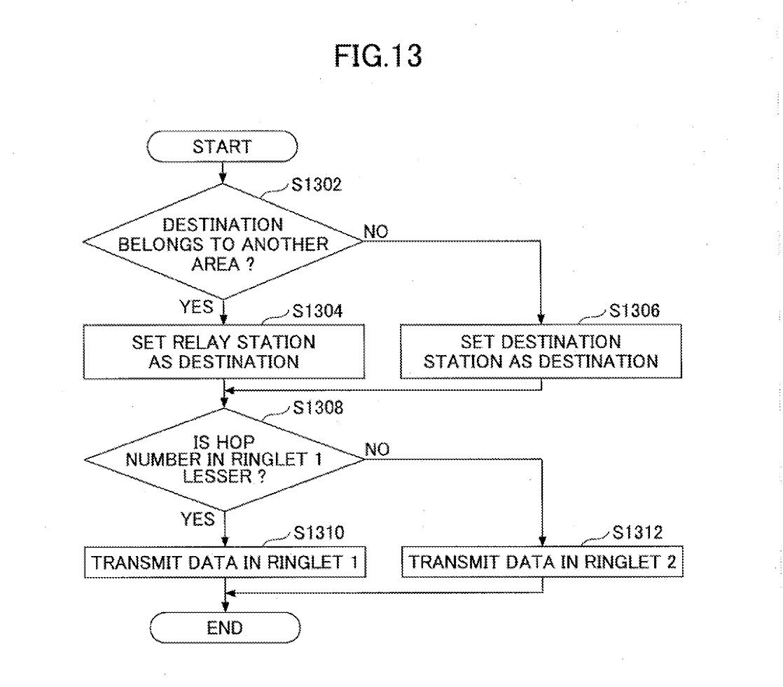

FIG. 13 is an example flowchart of a process performed by the station 200ₙ when the above data transmission method 1 is used.

First, the station 200ₙ determines whether the destination belongs to another area (step S1302). Namely, the route controller 2066 determines whether the destination of the data to be input from the ring network interface 202 or the LAN interface 208 is a station which belongs to a ring network other than the ring network to which the station 200ₙ belongs.

When determining that the destination belongs to another area (YES in step S1302), the station 200ₙ sets the relay station 100 as the destination (step S1304). Namely, when determining that the destination of the data to be input from the ring network interface 202 or the LAN interface 208 is the station which belongs to a ring network other than the ring network to which the station 200ₙ belongs, the route controller 2066 sets the relay station 100 as the destination of the data.

On the other hand, when determining that destination does not belong to another area (NO in step S1302), the station 200ₙ sets the destination station as the destination (step S1306). Namely, when determining that the destination of the data to be input from the ring network interface 202 or the LAN interface 208 is a station which belongs to the ring network to which the station 200ₙ belongs, the route controller 2066 sets the destination station as the destination of the data.

After step S1304 or S1306, the station 200ₙ determines whether the hop number in the ringlet 1 direction to the destination is less than the hop number in the ringlet 2 direction (step S1308). Namely, the route controller 2066 refers to the route information to be stored in the storage 2068 and determines whether the hop number to the relay station 100 set in step S1304 or the station to be set in step S1306 in the ringlet direction 1 is lesser.

When determining that the hop number in the ringlet 1 direction is lesser (YES in step S1308), the station 200ₙ transmits the packet data in the ringlet 1 direction (step S1310). Namely, when determining that the hop number in the ringlet 1 direction is lesser, the route controller 2066 controls the switch 2062 so as to transmit the packet data in the ringlet 1 direction.

On the other hand, when determining that the hop number in the ringlet 1 direction is not lesser (NO in step S1308), the station 200ₙ transmits the packet data in the ringlet 2 direction (step S1312). Namely, when determining that the hop number in the ringlet 1 direction is not lesser, the route controller 2066 controls the switch 2062 so as to transmit the packet data in the ringlet 2 direction.

### Operational Flow of Relay Station 100

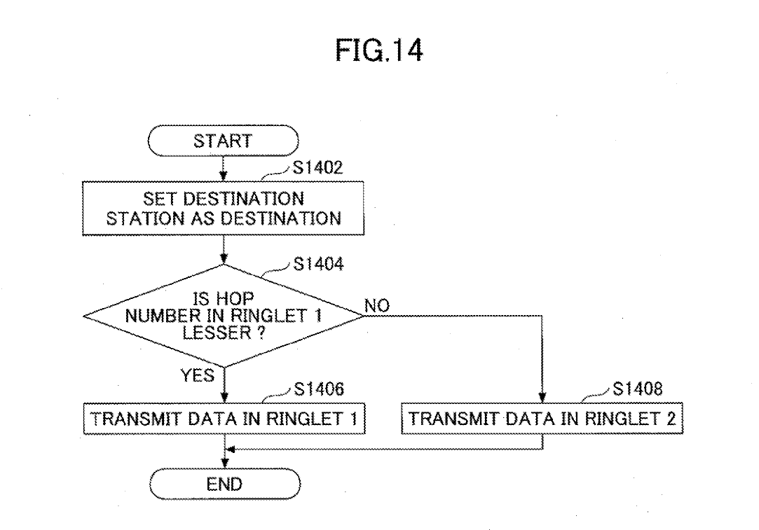

FIG. 14 is an example flowchart of a process performed by the relay station 100 when the above data transmission method 1 is used.

The relay station 100 sets the destination station as the destination (step S1402). Namely, the route controller 1066 sets the destination station of the data to be input from the ring network interface 202 or the LAN interface 208 as the destination of the data.

Then, the relay station 100 determines whether the hop number in the ringlet 1 direction to the destination is less than the hop number in the ringlet 2 direction (step S1404). Namely, by referring the route information to be stored in the storage 1068, the route controller 1066 determines whether the hop number to the station to be set in step S1402 in the ringlet direction 1 is less than the hop number in the ringlet 2 direction.

When determining that the hop number to the destination in the ringlet 1 direction is lesser (YES in step S1404), the relay station 100 transmits the packet data in the ringlet 1 direction (step S1406). Namely, when determining that the hop number in the ringlet 1 direction is lesser, the route controller 1066 controls the switch 1062 so as to transmit the packet data in the ringlet 1 direction.

On the other hand, when determining that the hop number in the ringlet 1 direction is not lesser (NO in step S1404), the relay station 100 transmits the packet data in the ringlet 2 direction (step S1408). Namely, when determining that the hop number in the ringlet 1 direction is not lesser, the route controller 1066 controls the switch 1062 so as to transmit the packet data in the ringlet 2 direction.

### Data Transmission Method 2

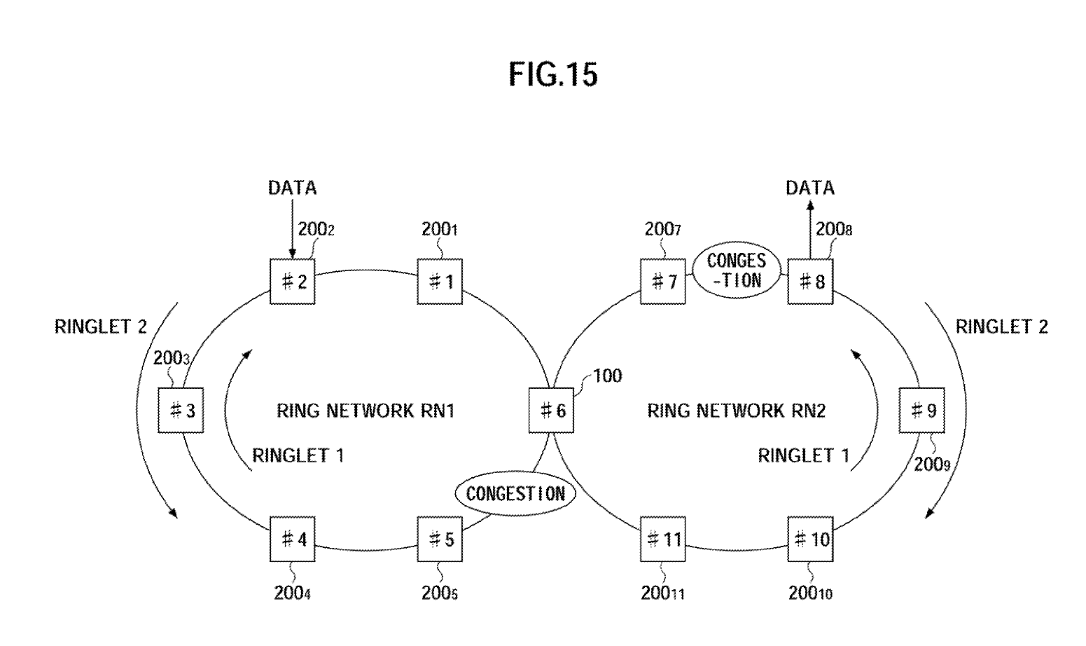

FIG. 15 illustrates another example of a data transmission method of this communication system.

In this example, a case is described where data are transmitted from the station 200₂ to the station 200₈. In the example of FIG. 15, it is determined that congestion occurs between the relay station 100 and the station 200₅ because at least one of a receiving buffer of the relay station 100 and the receiving buffer of the station 200₅ is equal to or greater than a threshold value, and it is also determined that congestion occurs between the station 200₇ and the station 200₈ because at least one of a receiving buffer of the station 200₇ and the receiving buffer of the station 200₈ is equal to or greater than the threshold value.

Namely in this data transmission method, an appropriate route may be determined (selected) based on not only the transmission length but also a congestion state.

Similar to the data transmission method 1, in this data transmission in the communication system, it is assumed that the network information relevant to the network including the relay station 100 and the station 200ₙ is set in the relay station 100 and the station 200ₙ, respectively.

To perform the data transmission in this system, each of the stations 200ₙ broadcasts packet data to all the other stations 200ₙ in the ring network to which the broadcasting station 200ₙ belongs, the packet data being for generating the route information indicating the arranging order in the ring network. For example, the station 200ₙ may broadcast a Topology discovery and Protection Frame. The process of broadcasting the Topology discovery and Protection Frame may be performed periodically or irregularly.

The relay station 100 broadcasts the identifier of the relay station 100 to all the stations 200ₙ. The process of broadcasting the identifier of the relay station 100 may be performed periodically or irregularly.

Further, the station 200ₙ monitors a state of the receiving buffer of the station 200ₙ. When determining that a value indicating the state of the receiving buffer is equal to or greater than a predetermined threshold value (i.e., when determining that the value indicating the state of the receiving buffer indicates congestion), the station 200ₙ broadcasts the congestion information indicating the congestion to any other stations 200ₙ and the relay station 100.

The stations 200ₙ having received the congestion information adds the data indicating the congestion information to the load information of the relevant stations. For example, as the congestion information, a congestion bit may be added as the indicating the congestion information. The process of broadcasting the congestion information may be performed periodically or irregularly. Further, the station 200ₙ may broadcast the congestion information when the congestion information of the station 200ₙ changes.

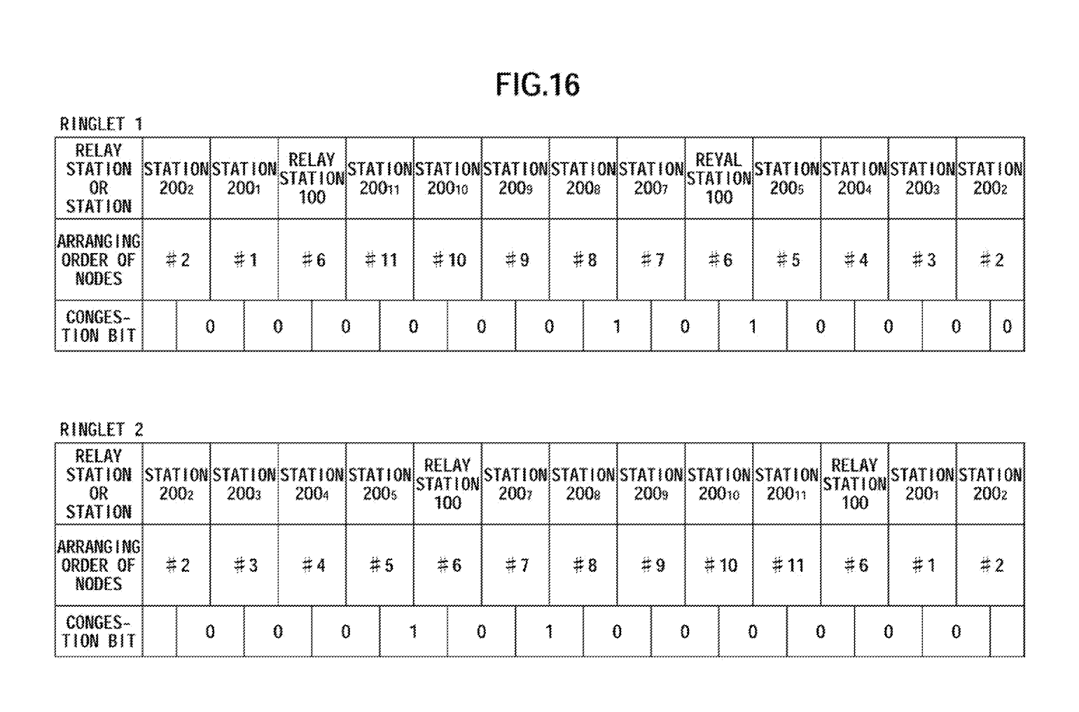

FIG. 16 illustrates an example of the route information and the load information to be generated (prepared) by the station 200ₙ, the route information indicating the arranging order of the stations in the ring network, the load information indicating the congestion information.

More specifically, FIG. 16 illustrates the route information and the load information to be generated by the station 200₂. As the load information, the congestion bit are added to the route information of the upper and the lower parts of FIG. 11. In the example of FIG. 16, a failure occurs between the relay station 100 and the station 200₅ and between the station 200₇ and the station 200₈. Therefore, the congestion bit “1” is added to the corresponding parts.

The ring network RN1 to which the station 200₂ belongs is different from the ring network RN2 to which the destination station 200₈ belongs. Therefore, the station 200₂ transmits the data to the relay station 100. When transmitting the data to the relay station 100, the station 200₂ basically transmits in the ringlet direction which corresponds to a shorter transmission length to the relay station 100.

Therefore, in this example, the station 200₂ basically transmits in the ringlet 1 direction. However, when congestion occurs in the route in the ringlet direction corresponding to a shorter transmission length, the other route where no congestion occurs is selected. In the case, the hop number may be used as the value corresponding to the transmission length.

For example, the station 200₂ may refer to the route information of FIG. 16, obtain the hop numbers in both ringlet directions to the relay station (relay node) 100, select the ringlet direction corresponding to lesser hop number, and transmit the data in the selected ringlet direction.

In the example of FIG. 16, the hop number from the station 200₂ to the relay station 100 in the ringlet 1 direction is “2”. On the other hand, the hop number from the station 200₂ to the relay station 100 in the ringlet 2 direction is “4”. Further, there is no congestion in the route having the lesser hop number.

Therefore, the station 200₂ transmits the data in the ringlet direction 1 corresponding to the route having the lesser hop number. As a result, the data from the station 200₂ are transmitted to the relay station 100 via the station 200₁.

The relay station 100 having received the data from the station 200₁ transfers the data to the station 200₈. When transferring (transmitting) the data to the station 200₈, the relay station 100 basically transmits in the ringlet direction which corresponds to a shorter transmission length to the station 200₈. Therefore, in this example, the relay station 100 basically transmits in the ringlet 2 direction.

However, when congestion occurs in the route in the ringlet direction corresponding to a shorter transmission length, the other route where no congestion occurs is selected. In the case, the hop number may be used as the value corresponding to the transmission length. For example, the relay station 100 may refer to the route information generated by the relay station 100, obtain the hop numbers in both ringlet directions to the station 200₈, select the ringlet direction corresponding to a lesser hop number, and transmit the data in the selected ringlet direction.

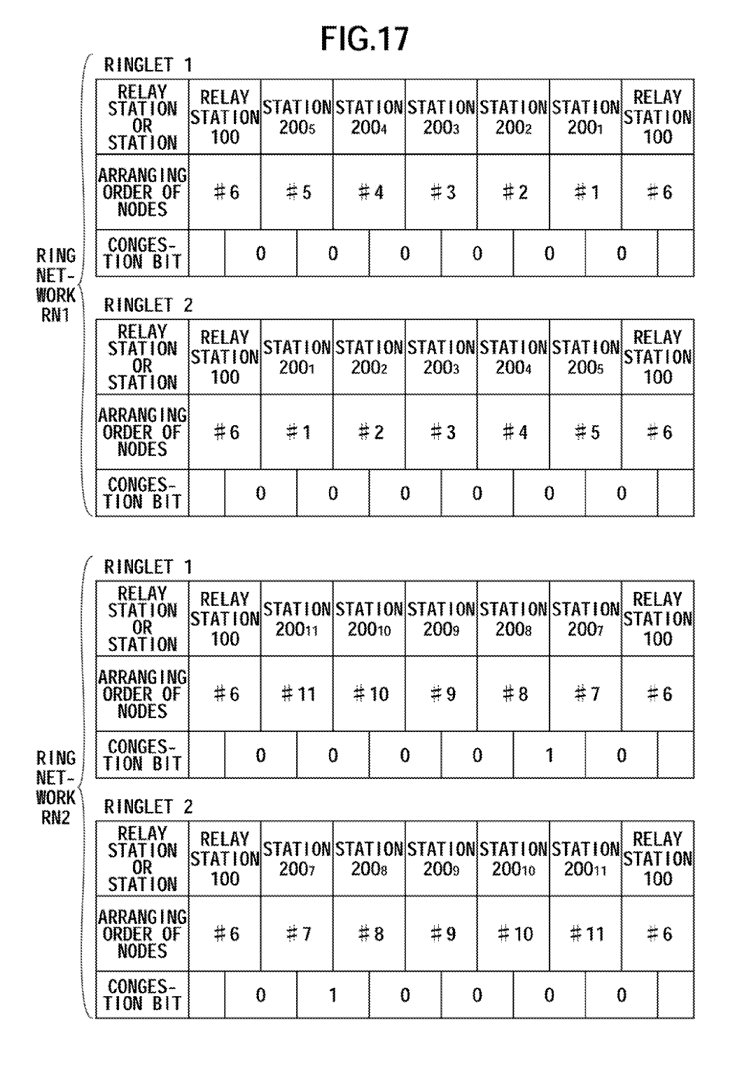

FIG. 17 illustrates an example of the route information and the load information to be generated by the relay station 100. In FIG. 17, the upper part illustrates the route information and the load information in the ring network RN1, and the lower part illustrates the route information and the load information in the ring network RN2.

In the example of FIG. 17, the hop number from the relay station 100 to the station 200₈ in the ringlet 1 direction is “4”. On the other hand, the hop number from the relay station 100 to the station 200₈ in the ringlet 2 direction is “2”. However, congestion occurs between the station 200₇ and the station 200₈ in the route corresponding to a shorter transmission length.

Therefore, the relay station 100 transmits the data in the ringlet direction 2 corresponding to the route where no congestion occurs. As a result, the data from the relay station 100 are transmitted to the relay station 200₈ via the station 200₁₁, the station 200₁₀, and the station 200₉.

In this data transmission method, similar to the data transmission method 1, data may be transmitted using a route having a shorter transmission length. Further, when congestion occurs in the route having a shorter transmission length, the other route where no congestion occurs may be selected.

In the RPR standard, the stations perform various operations autonomously. The various operations include protection and band limitation. Therefore, the station may not have to recognize a traffic status in any section where the station is not connected. However, by the data transmission method 2, the station may be able to recognize the congestion state of the sections where the station is not connected. As a result, delay in the data transmission and loss of the data may be reduced.

### Operational Flow of Stations 200ₙ

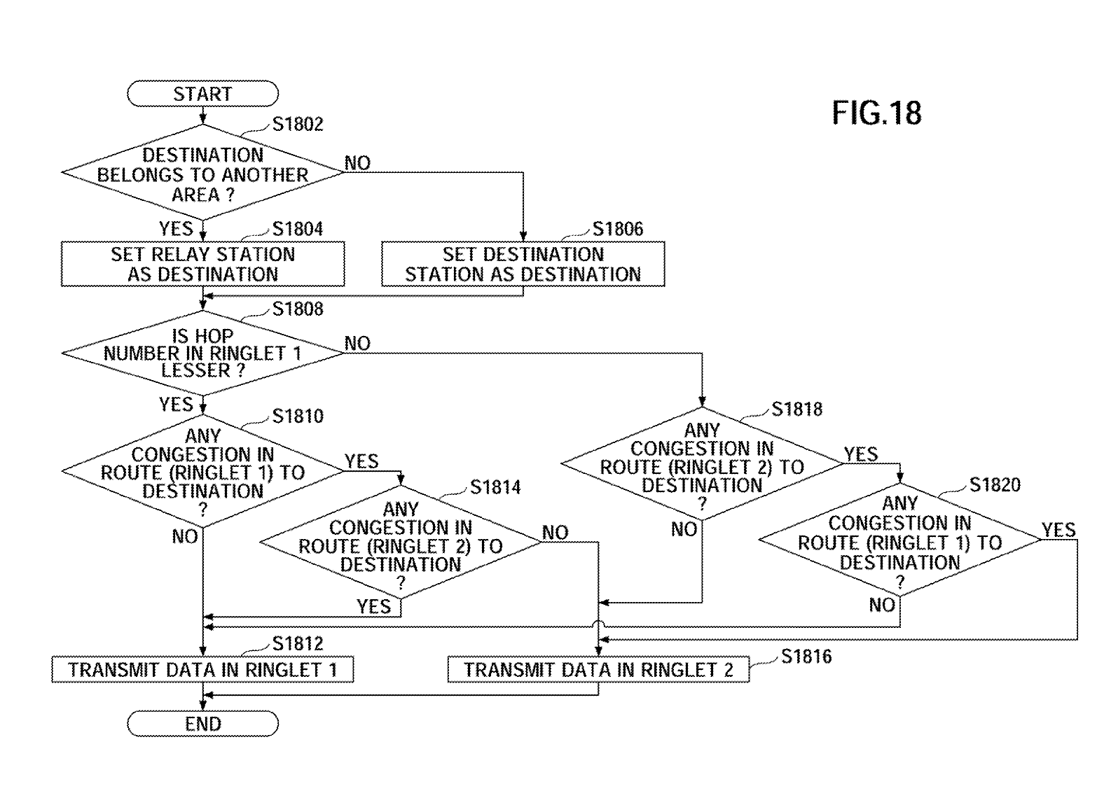

FIG. 18 is an example flowchart of a process performed by the stations 200ₙ when the above data transmission method 2 is used.

First, the station 200ₙ determines whether the destination belongs to another area (step S1802). Namely, the route controller 2066 determines whether the destination of the data to be input from the ring network interface 202 or the LAN interface 208 is a station 200ₙ which belongs to a ring network other than the ring network to which the station 200ₙ belongs.

When determining that the destination belongs to another area (YES in step S1802), the station 200ₙ sets the relay station 100 as the destination (step S1804). Namely, when determining that the destination of the data to be input from the ring network interface 202 or the LAN interface 208 is the station which belongs to a ring network other than the ring network to which the station 200ₙ belongs, the route controller 2066 sets the relay station 100 as the destination of the data.

On the other hand, when determining that destination does not belong to another area (NO in step S1802), the station 200ₙ sets the destination station 200ₙ as the destination (step S1806). Namely, when determining that the destination of the data to be input from the ring network interface 202 or the LAN interface 208 is the destination station 200ₙ which belongs to the ring network to which the station 200ₙ belongs, the route controller 2066 sets the destination station 200ₙ as the destination of the data.

After step S1804 or S1806, the station 200ₙ determines whether the hop number in the ringlet 1 direction to the destination is less than the hop number in the ringlet 2 direction (step S1808). Namely, the route controller 2066 refers to the route information to be stored in the storage 2068 and determines whether the hop number to the relay station 100 set in step S1804 or the destination station 200ₙ to be set in step S1806 in the ringlet direction 1 is lesser.

When determining that the hop number in the ringlet 1 direction is lesser (YES in step S1808), the station 200ₙ determines whether congestion occurs in the route to the destination in the ringlet 1 direction (step S1810). Namely, the route controller 2066 refers to the load information to be stored in the storage 2068 and determines whether there is congestion occurring in the route to the destination.

When determining that there is no congestion in the route to the destination (NO in step S1810), the station 200ₙ transmits the data (packet data) in the ringlet 1 direction (step S1812). Namely, when determining that there is no congestion in the route to the destination, the route controller 2066 controls the switch 2062 so that the data are transmitted in the ringlet 1 direction.

On the other hand, when determining that there is congestion in the route to the destination (YES in step S1810), the station 200ₙ further determines whether there is congestion in the route in the ringlet 2 direction, the route being other than the route which is determined as the route where there is the congestion (step S1814). Namely, the route controller 2066 refers to the load information to be stored in the storage 2068 and determines whether there is congestion in the route in the ringlet 2 direction to the destination.

When determining that there is congestion in the route in the ringlet 2 direction to the destination (YES in step S1814), the station 200ₙ transmits the data in the ringlet 1 direction (step S1812). The reason for this is as follows. This is the case where the congestion occurs in both routes. Therefore, in this case, it may be assumed that the lesser the hop number is, the sooner the data can be transmitted to the destination. Based on this determination, in this example, the route controller 2066 controls the switch 2062 so that the data are transmitted in the ringlet 1 direction.

On the other hand, when determining that there is no congestion in the route in the ringlet 2 direction to the destination (NO in step S1814), the station 200ₙ transmits the data in the ringlet 2 direction (step S1816). Namely, when determining that there is no congestion in the route in the ringlet 2 direction to the destination, the route controller 2066 controls the switch 2062 so that the data are transmitted in the ringlet 2 direction.

When determining that the hop number in the ringlet 1 direction is not lesser (NO in step S1808), the station 200ₙ determines whether congestion occurs in a route other than the route which is determined as the route where congestion occurs in step S1808 (step S1818). Namely, in this case, the station 200ₙ determines whether congestion occurs in the route in the ringlet 1 direction. Namely, the route controller 2066 refers to the load information to be stored in the storage 2068 and determines whether there is congestion occurring in the route to the destination.

When determining that there is no congestion in the route to the destination (NO in step S1818), the station 200ₙ transmits the packet data in the ringlet 2 direction (step S1816). Namely, when determining that there is no congestion in the route in the ringlet 2 direction, the route controller 2066 controls the switch 2062 so that the data are transmitted in the ringlet 2 direction.

On the other hand, when determining that there is congestion in the route to the destination (YES in step S1818), the station 200ₙ further determines whether there is congestion in a route other than the route which is determined as the route where there is the congestion in step 1818 (step S1820). In this case, the station 200ₙ determines whether there is congestion in the route in the ringlet 1 direction. Namely, the route controller 2066 refers to the load information to be stored in the storage 2068 and determines whether there is congestion occurring in the route in the ringlet direction 1 to the destination.

When determining that there is no congestion in the route in the ringlet 1 direction to the destination in step S1820 (NO in step S1820), the station 200ₙ transmits the packet data in the ringlet 1 direction (step S1812). This is because it may be assumed that the route having no congestion is preferably used to transmit data. Namely, when determining that there is no congestion in the route in the ringlet 1 direction to the destination, the route controller 2066 controls the switch 2062 so that the packet data are transmitted in the ringlet 1 direction.

When determining that there is congestion in the route in the ringlet 1 direction to the destination in step S1820 (YES in step S1820), the station 200ₙ transmits the packet data in the ringlet 2 direction (step S1816). The reason of this is as follows: This is the case where the congestion occurs in both routes. Therefore, in this case, it may be assumed that the lesser the hop number is, the sooner the data can be transmitted to the destination. Based on this determination, in this example, the route controller 2066 controls the switch 2062 so that the data are transmitted in the ringlet 2 direction.

### Operational Flow of Relay Station 100

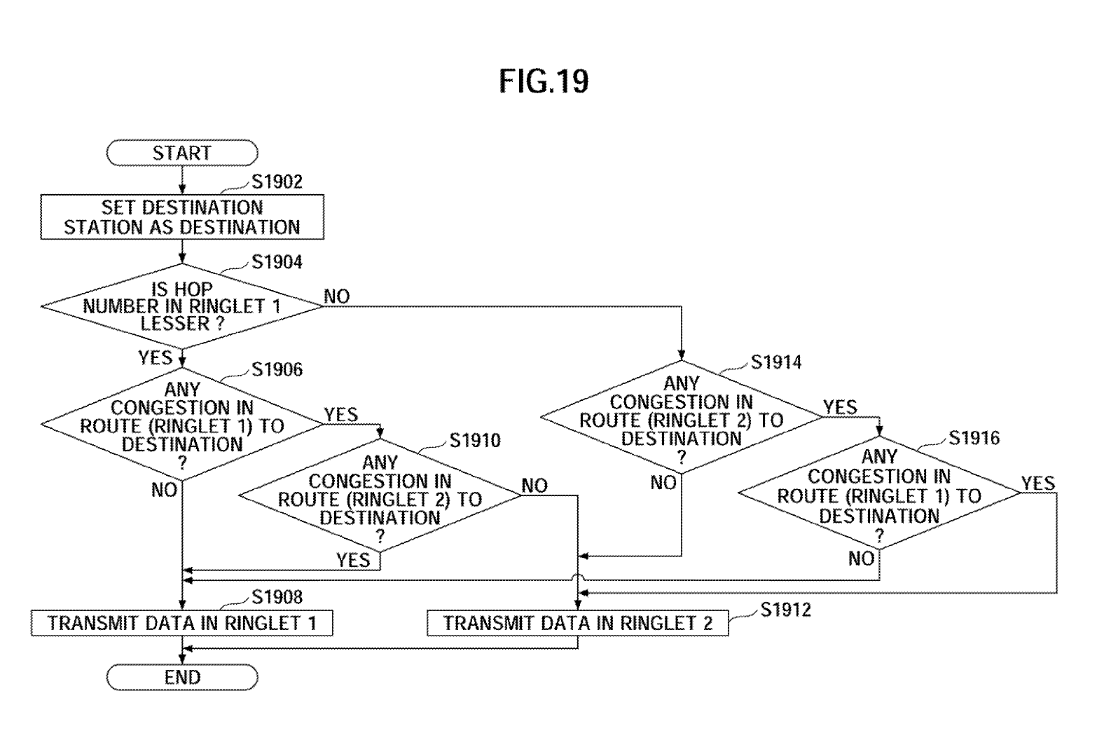

FIG. 19 is an example flowchart of a process performed by the relay station 100 when the above data transmission method 2 is used.

The relay station 100 sets the destination station as the destination (step S1902). Namely, the route controller 1066 sets the destination station of the data to be input from the ring network interface 202 or the LAN interface 208 as the destination of the data.

Then, the relay station 100 determines whether the hop number in the ringlet 1 direction to the destination is less than the hop number in the ringlet 2 direction (step S1904). Namely, by referring to the route information to be stored in the storage 1068, the route controller 1066 determines whether the hop number to the station to be set in step S1902 in the ringlet direction 1 is less than the hop number in the ringlet 2 direction.

When determining that the hop number to the destination in the ringlet 1 direction is lesser (YES in step S1904), the relay station 100 further determines whether there is congestion in the route in the ringlet 1 direction to the destination (step S1906). Namely, the route controller 1066 refers to the load information to be stored in the storage 1068 and determines whether there is congestion in the route to the destination.

When determining that there is no congestion in the route to the destination (NO in step S1906), the relay station 100 transmits the packet data in the ringlet 1 direction (step S1908). Namely, when determining that there is no congestion in the route in the ringlet 1 direction, the route controller 2066 controls the switch 2062 so that the data are transmitted in the ringlet 1 direction.

On the other hand, when determining that there is congestion in the route to the destination (YES in step S1906), the relay station 100 further determines whether there is congestion in a route other than the route which is determined as the route where there is the congestion in step S1906 (step S1910). In this case, the station 200ₙ determines whether there is congestion in the route in the ringlet 2 direction. Namely, the route controller 1066 refers to the load information to be stored in the storage 1068 and determines whether there is congestion occurring in the route in the ringlet direction 2 to the destination.

When determining that there is congestion in the route in the ringlet 2 direction to the destination (YES in step S1910), the relay station 100 transmits the packet data in the ringlet 1 direction (step S1908). The reason for this is as follows. This is the case where the congestion occurs in both routes. Therefore, in this case, it may be assumed that the less the hop number is, the sooner the data can be transmitted to the destination. Based on this determination, in this example, the route controller 1066 controls the switch 1062 so that the data are transmitted in the ringlet 1 direction.

When determining that there is no congestion in the route in the ringlet 2 direction to the destination in step S1910 (NO in step S1910), the relay station 100 transmits the packet data in the ringlet 2 direction (step S1912). Namely, when determining that there is no congestion in the route in the ringlet 2 direction to the destination, the route controller 1066 controls the switch 1062 so that the packet data are transmitted in the ringlet 2 direction.

When determining that the hop number in the ringlet 1 direction is not lesser (NO in step S1904), the relay station 100 determines whether congestion occurs in a route other than the route which is determined as the route where congestion occurs in step S1904 (step S1914). Namely, in this case, the relay station 100 determines whether congestion occurs in the route in the ringlet 2 direction. Namely, the route controller 1066 refers to the load information to be stored in the storage 1068 and determines whether there is congestion occurring in the route to the destination.

When determining that there is no congestion in the route to the destination (NO in step S1914), the relay station 100 transmits the packet data in the ringlet 2 direction (step S1912). Namely, when determining that there is no congestion in the route in the ringlet 2 direction, the route controller 1066 controls the switch 1062 so that the data are transmitted in the ringlet 2 direction.

On the other hand, when determining that there is congestion in the route to the destination (YES in step S1914), the relay station 100 further determines whether there is congestion in a route other than the route which is determined as the route where there is the congestion in step 1914 (step S1916). In this case, the relay station 100 determines whether there is congestion in the route in the ringlet 1 direction. Namely, the route controller 1066 refers to the load information to be stored in the storage 1068 and determines whether there is congestion occurring in the route in the ringlet direction 1 to the destination.

When determining that there is no congestion in the route in the ringlet 1 direction to the destination in step S1916 (NO in step S1916), the relay station 100 transmits the packet data in the ringlet 1 direction (step S1908). This is because it may be assumed that the route having no congestion is preferable to transmit data. Namely, when determining that there is no congestion in the route in the ringlet 1 direction to the destination, the route controller 1066 controls the switch 1062 so that the packet data are transmitted in the ringlet 1 direction.

When determining that there is congestion in the route in the ringlet 1 direction to the destination in step S1916 (YES in step S1916), the relay station 100 transmits the packet data in the ringlet 2 direction (step S1912). The reason for this is as follows. This is the case where the congestion occurs in both routes. Therefore, in this case, it may be assumed that the less the hop number is, the sooner the data can be transmitted to the destination. Based on this determination, in this example, the route controller 1066 controls the switch 1062 so that the data are transmitted in the ringlet 2 direction.

### Modified Example

Next, a modified example is described. The system in this modified example is the same as the system described with reference to FIG. 5.

The relay station 100 and the station 200ₙ in this modified example are the same as those in the relay station 100 described with reference to FIG. 8 and the station 200ₙ described with reference to FIG. 9.

In this modified example, an operation when a failure occurs in the communication system will be described.

### Operational Example of Communication System

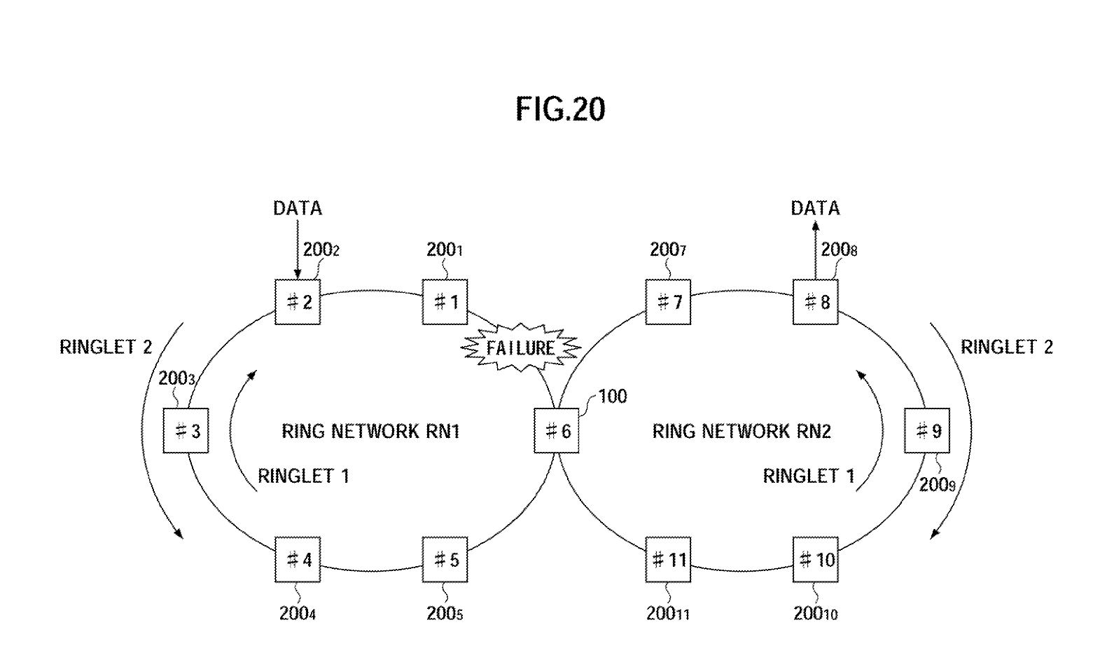

FIG. 20 illustrates an example where a failure occurs in the communication system. More specifically, in the example of FIG. 20, a failure occurs between the station 200₁ and the relay station (relay node) 100.

Under the condition, a case is described where data are transmitted from the station 200₂ to the station 200₈.

In the data transmission in the communication system, it is assumed that the network information relevant to the network including the relay station 100 and the stations 200ₙ is set in the relay station 100 and the stations 200ₙ, respectively.

To perform the data transmission in this system, each of the stations 200ₙ broadcasts packet data to all the other stations 200ₙ in the ring network to which the station 200ₙ belongs, the packet data being for generating the route information indicating the arranging order in the ring network.

Further, the relay station 100 broadcasts the identifier of the relay station 100 to all the stations 200ₙ.

Further, when determining that a value indicating the state of the receiving buffer is equal to or greater than a predetermined threshold value (i.e., when determining that the value indicating the state of the receiving buffer indicates congestion), the station 200ₙ may broadcast the congestion information indicating the congestion to any other stations 200ₙ and the relay station 100.

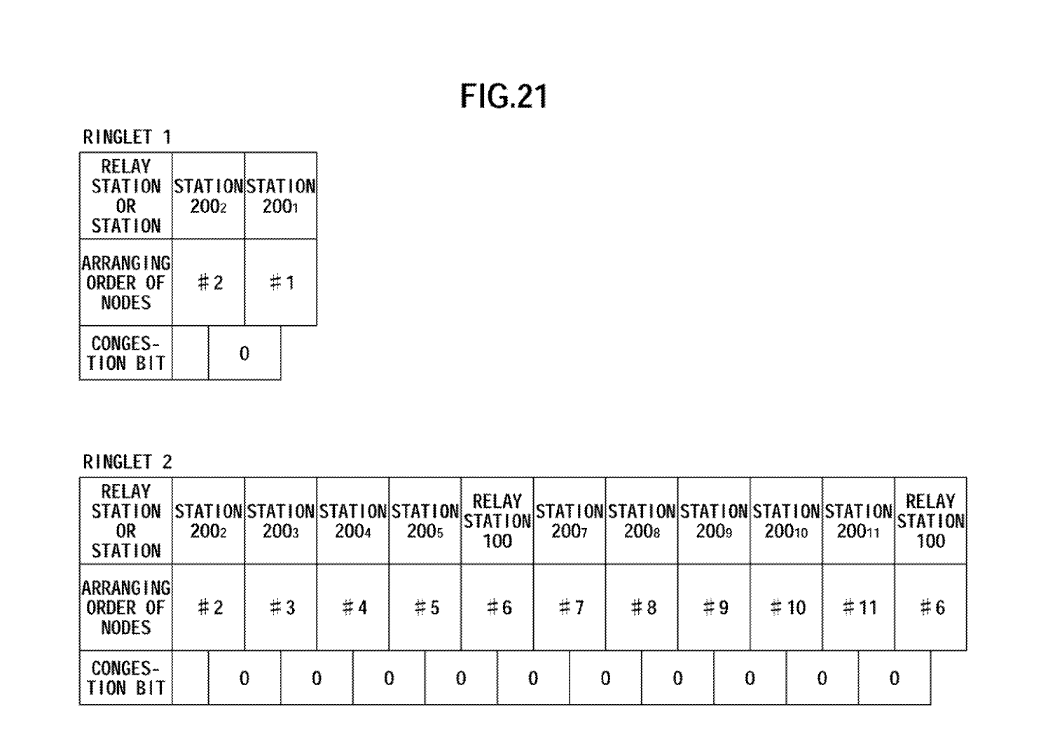

FIG. 21 illustrates an example of the route information and the load information to be generated by the station 200ₙ, the route information indicating the arranging order of the stations in the ring network, the load information indicating the congestion state.

More specifically, as an example, FIG. 21 illustrates the route information to be generated by the station 200₂. A failure occurs between the station 200₁ and the relay station (relay node) 100. Therefore, the station 200₂ may not recognize the stations beyond the station 200₁ in the ringlet 1 direction. As a result, the route information and the load information in the ringlet 1 direction are as illustrated in the upper part of FIG. 21.

Further, the station 200₂ may not recognize the stations 200ₙ beyond the relay station 100 in the ringlet 2 direction. As a result, the route information and the load information in the ringlet 2 direction are as illustrated in the lower part of FIG. 21.

Further, as illustrated in FIG. 21, not only the route information indicating the arrangement order of the stations (nodes) 200ₙ but also the load information using the congestion bit may be stored.

The ring network RN1 to which the station 200₂ belongs to is different from the ring network RN2 to which the destination station 200₈ belongs. Therefore, the station 200₂ transmits the data to the relay station 100. When transmitting the data to the relay station 100, the station 200₂ refers to the route information of FIG. 21 and transmits data in the ringlet 1 direction or in the ringlet 2 direction.

In the example of FIG. 21, the relay station to be the destination of the data is listed in the ringlet 2 direction only. Therefore, the station 200₂ transmits the data the in the ringlet 2 direction. As a result, the data from the station 200₂ are transmitted to the relay station 100 via the station 200₃, the station 200₄, and the station 200₅.

The relay station 100 having received the data from the station 200₁ transfers the data to the station 200₈. In this case, the relay station 100 selects the station to which the data is to be sent by referring to the route information.

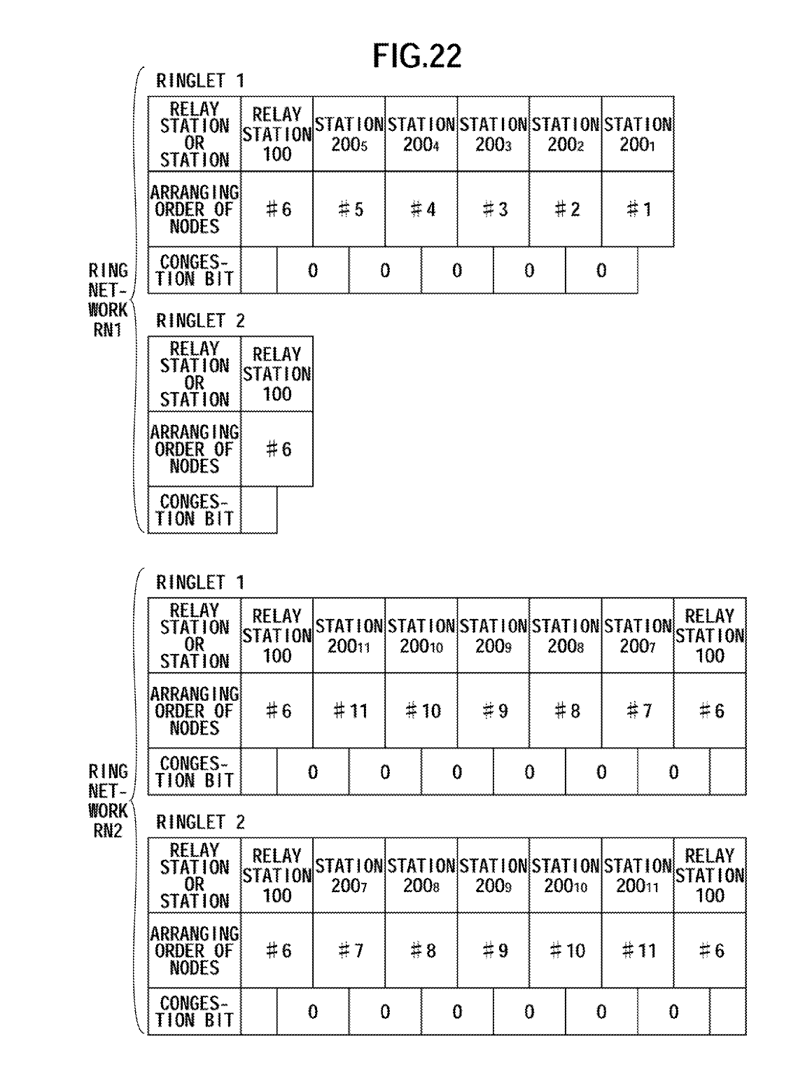

FIG. 22 illustrates an example of the route information and the load information to be generated by the relay station 100. More specifically, the route information and the load information in the ring network RN1 are illustrated in upper portion of FIG. 22, and the route information and the load information in the ring network RN2 are illustrated in lower portion of FIG. 22.

In the example of FIG. 22, as the arrangement order of the stations (nodes) in the ringlet 1 direction in the ring network RN1, data of the station 200₅, the station 200₄, the station 200₃, the station 200₂, and the station 200₁ are collected. However, since a failure occurs between the station 200₁ and the relay station 100, as the arrangement order of the stations (nodes) in the ringlet 2 direction in the ring network RN1, only the data of the relay station 100 is collected.

On the other hand, since no failure occurs in the ring network RN2, the data of all the stations 200ₙ belonging to the ring network RN2 may be acquired. In the ring network RN2, the hop number from the relay station 100 to the station 200₃ in the ringlet 1 direction is “4” and the hop number from the relay station 100 to the station 200₃ in the ringlet 2 direction is “2”. Further, there is no congestion in the route having a shorter transmission length. Therefore, the data are transmitted using the route in the ringlet 2 direction and having a shorter transmission length. As a result, the data from the relay station 100 are transmitted to the station 200₈ via the station 200₇.

The operations of this communication system are similar to those described in the above examples. However, when the ringlet direction is selected in the ring network where a failure occurs, there may be the station to be the destination in only one ringlet direction. Therefore, not the route having a shorter transmission length but the route in the ringlet direction where the station to be the destination exists is selected.

In the examples and the modified example, it may become possible to effectively construct the transmission route in a practical setting environment by connecting the stations included in the ring networks in a unicursal form (in a one-stroke drawing form). Further, the transmission lengths may be reduced, thereby enabling reducing the cost and the transmission delay. Further, when congestion occurs, an appropriate route may effectively selected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiment of the present inventions has been described in detail, it is to be understood that various changes, substitutions, and alterations could be made hereto without departing from the sprit and scope of the invention.

What is claimed is:

1. A relay station for relaying data between first and second ring networks, each of the first and the second ring networks including a plurality of stations, the relay station comprising:
a first transmission and receiving circuit configured to transmit and receive data to and from the first ring network;
a second transmission and receiving circuit configured to transmit and receive the data to and from the second ring network; and
a switch configured to, when a destination of the data received by the first transmission and receiving circuit is one of the stations included in the second ring network, input the data to the second transmission and receiving circuit, and when a destination of the data received by the second transmission and receiving circuit is another of the stations included in the first ring network, input the data to the first transmission and receiving circuit.

2. The relay station according to claim 1,
wherein, a first ringlet direction is determined in the first ring network and a second ringlet direction is determined in the second ringlet direction, the first ringlet direction corresponding to a first data transmission direction, the second ringlet direction corresponding to a second data transmission direction opposite to the first data transmission direction,
wherein the first transmission and receiving circuit includes
a first ring transmission and receiving unit configured to transmit and receive the data in the first ringlet direction of the first ring network, and
a second ring transmission and receiving unit configured to transmit and receive the data in the second ringlet direction of the first ring network, and
wherein the second transmission and receiving circuit includes
a third ring transmission and receiving unit configured to transmit and receive data in the first ringlet direction of the second ring network, and
a fourth ring transmission and receiving unit configured to transmit and receive data in the second ringlet direction of the second ring network.

3. The relay station according to claim 2, further comprising:
a route information storage configured to store route information generated based on information to be broadcasted to all of the stations; and
a route setter configured to set a route through which the data are to be transmitted based on the route information stored in the route information storage,
wherein, based on the route to be set by the route setter, the switch is configured to, when the destination of the data received by the first transmission and receiving circuit is the one of the stations in the second ring network, input the data to one of the third ring transmission and receiving unit and the fourth ring transmission and receiving unit of the second transmission and receiving circuit, and, when the destination of data received by the second transmission and receiving circuit is the other of the stations in the first ring network, input the data to one of the first ring transmission and receiving unit and the second ring transmission and receiving unit of the first transmission and receiving circuit.

4. The relay station according to claim 3, further comprising:
a congestion information storage configured to store congestion information of the first and the second ring networks, the congestion information being generated based on information indicating a congestion state and to be broadcasted to all the stations,
wherein the route setter is configured to set a route through which the data are to be transmitted based on the congestion information stored in the congestion information storage.

5. The relay station according to claim 3,
wherein the route setter is configured to set the route through which the data are to be transmitted to a route having a shorter distance from the relay station.

6. The relay station according to claim 4,
wherein the route setter is configured to set the route through which the data are to be transmitted to a route without congestion.

7. A relay method in a relay station for relaying data between first and second ring networks, each of the first and the second ring networks including a plurality of stations, the relay method comprising:
receiving data from a first station;
determining whether a destination of the data received in the receiving is a destination station belonging to a ring network same as the ring network to which the first station belongs;
transmitting, when not determining that the destination of the data received in the receiving is the destination station belonging to the ring network the same as the ring network to which the first station belongs, the data to the ring network to which the station to be the destination of the data belongs.

8. A relay station for relaying data between first and second ring networks, each of the first and the second ring networks including a plurality of stations, the relay station comprising:
a first transmission and receiving circuit configured to transmit and receive data to and from the first ring network;
a second transmission and receiving circuit configured to transmit and receive data to and from the second ring network; and
a switch configured to input data to the second transmission and receiving circuit, the data having been received by the first transmission and receiving circuit and input data to the first transmission and receiving circuit, the data having been received by the second transmission and receiving circuit.
